(19) United States
(12) Patent Application Publication
(10) Pub. No.: US 2017/0248185 A1
(43) Pub. Date: Aug. 31, 2017

(54) BRAKE DEVICE

(71) Applicants: TOYOTA JIDOSHA KABUSHIKI KAISHA, Toyota-shi (JP); ALCHEMICA CORPORATION, Susono-shi (JP)

(72) Inventors: Hiroshi ISONO, Susono-shi (JP); Nobuyoshi SUGITANI, Susono-shi (JP); Aizoh KUBO, Kyoto-shi (JP)

(73) Assignees: TOYOTA JIDOSHA KABUSHIKI KAISHA, Toyota-shi (JP); ALCHEMICA CORPORATION, Susono-shi (JP)

(21) Appl. No.: 15/444,961

(22) Filed: Feb. 28, 2017

(30) Foreign Application Priority Data
Feb. 29, 2016 (JP) 2016-037062

(51) Int. Cl. F16D 65/853; F16D 55/30; F16D 69/00; F16D 65/18

(52) U.S. Cl. CPC F16D 65/853; F16D 65/186; F16D 55/30; F16D 69/00; F16D 2065/787

(57) ABSTRACT

A brake device that can be cooled effectively while reducing a friction loss of a rotary member is provided. In the brake device, a second friction face formed on a brake stator is brought into contact to a first friction face formed on a brake rotor to stop rotation of a rotary shaft, and coolant is held in a casing. The brake device comprises a first cooling groove formed on the brake rotor to allow the coolant to flow over the first friction face, and a second cooling groove formed on the brake stator to allow the coolant to flow over the second friction face.

### CROSS REFERENCE TO RELATED APPLICATION

The present invention claims the benefit of Japanese Patent Application No. 2016-037062 filed on Feb. 29, 2016 with the Japanese Patent Office, the disclosures of which are incorporated herein by reference in its entirety.

### BACKGROUND

Field of the Invention

Embodiments of the present application relate to the art of a brake device for stopping rotation of an output shaft of a motor, and especially to a wet-type brake device in which an exothermic portion is cooled by coolant such as water and oil.

Discussion of the Related Art

JP-A-2009-281491 describes a wet-type brake device used in a machinery requiring a large brake such as a construction machinery. In the brake device taught by JP-A-2009-281491, a rotary brake plate connected to an axle is brought into contact to a non-rotary brake by a piston to stop the rotation of the axle. The rotary brake plate is immersed in oil to be lubricated and cooled, and provided with an annular base plate connected to the axle, and an annular friction part disposed on the surface of the base plate concentrically therewith. An oil path is formed radially on the rotary brake plate from an inner peripheral edge and an outer peripheral edge to deliver the oil between the friction part and the base plate.

JP-A-2008-95941 describes a ventilated disk rotor which inhibits occurrence of a brake noise. The ventilated disk rotor is provided with a plurality of cooling fins extending radially on the disk rotor.

The wet-type brake device taught by JP-A-2009-281491 may be cooled effectively in comparison with dry-type brake devices. In the brake device taught by JP-A-2009-281491, however, a friction loss of the rotary brake plate may be caused by the oil.

### SUMMARY

Aspects of embodiments of the present application have been conceived noting the foregoing technical problems, and it is therefore an object of embodiments of the present invention is to provide a brake device that can be cooled effectively while reducing a friction loss of a rotary member caused by coolant.

The present application relates to a brake device, comprising: a brake stator that is restricted to rotate around a predetermined rotary shaft; a brake rotor that is fitted onto the rotary shaft in such a manner as to rotate integrally with the rotary shaft and relatively to the brake stator; a casing holding the brake stator and the brake rotor; and a first friction face formed on an outer circumferential portion of the brake rotor and a second friction face formed on an outer circumferential portion of the brake stator that are brought into contact with each other to stop rotation of the rotary shaft. In order to achieve the above-explained objective, according to the embodiment of the present application, the brake device is provided with: a hollow passage formed in the rotary shaft; a coolant held in the casing to cool the brake stator and the brake rotor in an amount possible to immerse the rotary shaft at least partially and to flow through the hollow passage; a first cooling groove formed on the brake rotor in such a manner as to open toward the second friction face, so as to allow the coolant to flow from an inner circumferential edge to an outer circumferential edge of the first friction face; and a through passage penetrating through the brake rotor across the rotary shaft to allow the coolant flowing through the hollow passage to flow into the first cooling groove.

In a non-limiting embodiment, the brake device may further comprise a second cooling groove formed on the second friction face that opens toward the first friction face to allow the coolant flowing through the first cooling groove partially enters thereinto.

In a non-limiting embodiment, a plurality of the first cooling grooves and a plurality of the through passages may be formed radially around a rotational center axis of the rotary shaft.

In a non-limiting embodiment, the brake stator may be magnetically attracted toward the brake rotor when energized to stop the rotation of the rotary shaft.

In a non-limiting embodiment, a motor in which the rotary shaft serves as an output shaft may also be held in the casing. In addition, the coolant not only cools the brake stator and the brake rotor but also cools and lubricates the motor.

According to the embodiment of the present application, the brake rotor serves as a centrifugal pump when rotated to circulate the coolant within the casing through the hollow passage and the first friction face. According to the embodiment of the present application, therefore, the brake rotor and the brake stator can be cooled effectively. In addition, when the second friction face is brought into contact to the first friction face to stop the rotation of the rotary shaft, an opening of the first cooling groove is almost closed by the second friction face. Consequently, pumping pressure of the centrifugal pump formed by the rotary shaft and the brake rotor can be enhanced. For this reason, the brake rotor and the brake stator can be cooled more effectively when heated by friction resulting from engagement between the first friction face and the second friction face. By contrast, when the second friction face is isolated away from the first friction face, the pumping pressure of the centrifugal pump is reduced. In this case, a frictional loss between the brake rotor and the coolant may be reduced.

As described, the brake stator is also provided with the second cooling groove. According to the embodiment of the present application, therefore, the brake stator may also be cooled effectively by the coolant flowing through the second cooling groove.

As also described, a plurality of the first cooling grooves and a plurality of the through passages are formed radially around a rotational center axis of the rotary shaft. According to the embodiment of the present application, therefore, the coolant is allowed to flow efficiently from the hollow passage to the first friction face to cool the brake rotor and the brake stator effectively. Here, it is to be noted that the through passages and the first cooling grooves may be formed in a manner not only to extend in the radial direction of the brake rotor, but also to be inclined with respect to the radial direction. Optionally, the through passages and the first cooling grooves may be bent or curved in a predetermined circumferential direction of the brake rotor, or may be formed into a spiral form.

As also described, the brake stator is magnetically attracted toward the brake rotor when energized to stop the rotation of the rotary shaft. That is, the brake device according to the embodiment of the present application is an electromagnetic brake. For this reason, a hydraulic system and reinforcements such as a brake caliper and so on may be omitted, and hence the brake device may be downsized and lightened.

In addition, since the brake device and the motor are held in the common casing, both of the brake device and the motor can be cooled and lubricated by the common coolant. According to the embodiment of the present application, therefore, the brake device and the motor can be cooled and lubricated efficiently by the coolant.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a cross-sectional view showing a preferred embodiment of the brake device according to the present application;

FIG. 2 is a schematic illustration partially showing one example of the brake rotor of the brake device shown in FIG. 1;

FIG. 3 is a schematic illustration partially showing one example of the brake stator of the brake device shown in FIG. 1; and

FIG. 4 is a schematic illustration partially showing another example of the brake stator shown in FIG. 3.

### DETAILED DESCRIPTION OF THE PREFERRED EMBODIMENT(S)

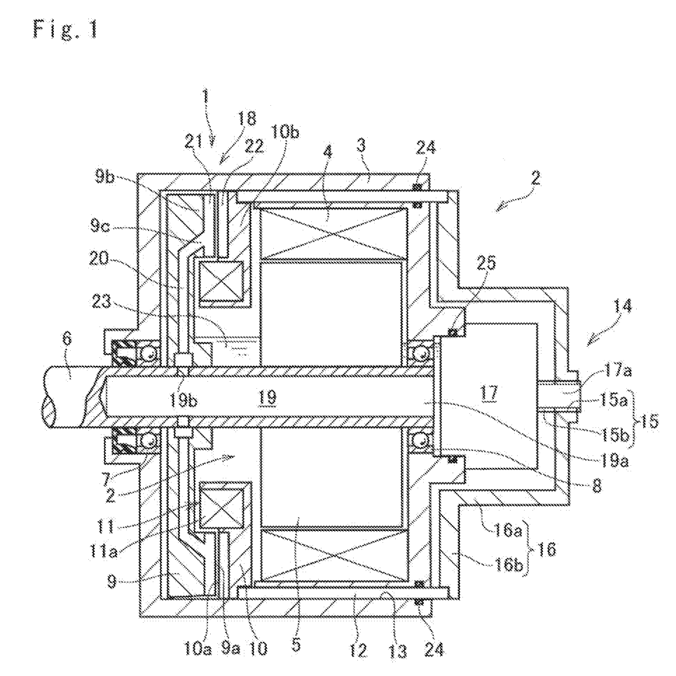

Preferred embodiment of the present application will now be explained with reference to the accompanying drawings. Referring now to FIG. 1, there is shown a brake device according to the preferred embodiment of the present application. As illustrated in FIG. 1, the brake device 1 and the motor 2 are held in a common casing 3.

The motor 2 is intended to be used as a prime mover of an automobile, and for example, a permanent magnet synchronous motor, and an induction motor may be used as the motor 2. Specifically, the motor 2 comprises a stator 4 that is fixed to an inner face of the casing 3, a motor shaft 6 as an output shaft of the motor 2 that is supported by bearings 7 and 8 in a rotatable manner at both ends of the casing 3, and a rotor 5 that is fitted onto the motor shaft 6 to be rotated integrally with the motor shaft 6 but relatively to the stator 4. One of end portions of the motor shaft 6 (of the left side in FIG. 1) protrudes from the casing 3, and the other end portion of the motor shaft 6 (of the right side in FIG. 1) is held in the casing 3.

The brake device 1 is adapted to stop rotation of a predetermined rotary shaft. Specifically, the brake device 1 is an electromagnetic brake that stops the rotation of motor shaft 6 of the motor 2 when energized. To this end, the brake device 1 is provided with a brake rotor 9, a brake stator 10, and a brake solenoid 11. When the brake solenoid 11 is energized, the brake stator 10 is brought into contact to the brake rotor 9 to generate braking torque for stopping the rotation of the motor shaft 6. That is, the brake device 1 will not generate braking torque unless the brake solenoid 11 is energized.

Specifically, the brake rotor 9 is a disc-shaped magnetic member, and the brake rotor 9 is also fitted onto the motor shaft 6 to be rotated integrally with the motor shaft 6. A first friction face 9a is formed on an outer circumferential portion 9b of one face of the brake rotor 9 to be opposed to a below-mentioned second friction face 10a of the brake stator 10.

The brake stator 10 is also an annular magnetic member, and the brake stator 10 is supported by at least two push rods 12 individually as a rod member or a pipe member at an outer circumferential portion of a face opposite to the second friction face 10a. Specifically, each of the push rod 12 is individually inserted into through holes 13 penetrating through the casing 3 in an axial direction, and one end of each of the push rod 12 is individually fitted into insertion holes or notches formed on the outer circumferential portion of the opposite face of the brake stator 10 to the second friction face 10a.

Thus, in the casing 3, the brake stator 10 is supported by the rod members 12 while being allowed to reciprocate in the axial direction but restricted to rotate around the motor shaft 6. That is, the push rods 12 serve as a torque receiving mechanism for restricting the rotation of the brake stator 10.

The above-mentioned second friction face 10a is formed on the outer circumferential portion 10b of the face of the brake stator 10 opposed to the first friction face 9a of the brake rotor 9. According to the preferred embodiment, the second friction face 10a is brought into directly contact to the first friction face 9a without using a brake pad or lining. In addition, the first friction face 9a is made of same magnetic material as the brake rotor 9 such as iron or cast iron, and the second friction face 10a is also made of same magnetic material as the brake stator 10 such as iron or cast iron.

The brake solenoid 11 comprises the brake rotor 9 serving as a fixed magnetic pole, a coil 1la wound around an iron core (not shown), and the brake stator 10 serving as a movable magnetic pole. The coil 11a is attached to the brake stator 10 so that the coil 11a is reciprocated together with the brake stator 10. Specifically, when a predetermined current is applied to the coil 11a, the coil 11a establishes magnetic attraction to be pulled toward the brake rotor 9 together with the brake stator 10. Consequently, the second friction face 10a of the brake stator 10 is frictionally engaged with the first friction face 9a of the brake rotor 9 to stop the rotation of the motor shaft 6. Optionally, although not especially illustrated in FIG. 1, a return spring may be used to isolate the second friction face 10a away from the first friction face 9a when stopping current supply to the coil 11a to allow the motor shaft 6 to rotate.

As described, the motor 2 is used as a prime mover of an automobile, and for this purpose, the motor 2 is provided with a parking brake 14. Specifically, the parking brake 14 is adapted to generate thrust force for pushing the brake stator 10 toward the brake rotor 9 to keep stopping the rotation of the motor shaft 6.

The parking brake 14 is adapted to maintain the frictional engagement of the first friction face 9a and the second friction face 10a thereby stopping the rotation of the motor shaft 9 even when the coil 11a is unenergized. To this end, the parking brake 14 comprises the feed screw mechanism 15, a pushing member 16, and a brake motor 17.

The pushing member 16 includes a cover member 16a covering the brake motor 17 and a flange member 16b expanding radially outwardly from an opening of the cover member 16a. A female thread hole 15a is formed on a center of a bottom of the cover member 16a.

The brake motor 17 is held in the cover member 16a while being fixed to the casing 3. The other end of each of the push rod 15 is individually fitted into insertion holes or notches formed on an outer circumferential portion of a face of the flange member 16b being opposed to the casing 3.

A male thread 15b is formed on an outer circumferential surface of an output shaft 17a of the brake motor 17, and the male thread 15b is screwed into the female thread hole 15a of the cover member 16a.

For example, a ball screw actuator, a trapezoidal screw actuator, a square screw actuator etc. may serve as the female thread hole 15a and the male thread 15b. Specifically, the feed screw mechanism 15 generates a thrust force (or an axial force) for pushing the pushing member 16 in the axial direction toward the drive motor 2 by rotating the output shaft 17a of the brake motor 17 on which the male thread 15b is formed in a predetermined direction (i.e., in the forward direction). By contrast, the pushing member 16 is withdrawn from the drive motor 2 by rotating the output shaft 17a of the brake motor 17 in the opposite direction (i.e., in the reverse direction).

Thus, the feed screw mechanism 15 generates forward thrust force by generating forward torque by the brake motor 17, and the forward thrust force is applied to the brake stator 10 through the pushing member 16 and the push rods 12. Consequently, the brake stator 10 is pushed toward the brake rotor 9 so that the second friction face 10a of the brake stator 10 is frictionally engaged with the first friction face 9a of the brake rotor 9 to stop the rotation of the motor shaft 6. By contrast, the motor shaft 6 is allowed to rotate by generating a reverse torque by the brake motor 17 to withdraw the second friction face 10a of the brake stator 10 from the first friction face 9a of the brake rotor 9. That is, the braking force for stopping the rotation of the motor shaft 6 is cancelled.

In addition, reversed efficiency of the feed screw mechanism 15 to translate linear motion to rotational motion is adjusted to be lower than forward efficiency to translate rotational motion to linear motion. That is, mechanical efficiency of the feed screw mechanism 15 is tuned in such a manner that the pushing member 16 is moved more efficiently toward the brake rotor 9 by rotating the male thread 15b in the forward direction, and that the male thread 15b is rotated in the reverse direction less efficiently by withdrawing the pushing member 16 from the brake rotor 9. According to the preferred embodiment, therefore, the motor shaft 6 may be halted easily by pushing the brake stator 10 toward the brake rotor 9 by the feed screw mechanism 15 even when the coil 11a of the brake solenoid 11 and the brake motor 17 are unenergized.

The brake device 1, especially the brake rotor 9 and the brake stator 10 are heated by friction as a result of stopping the rotation of the motor shaft 6. In order to cool the brake device 1 and the motor 2 by coolant in the casing 3, the brake device 1 is provided with a cooling system 18.

The cooling system 18 comprises a hollow passage 19 formed in the motor shaft 6, a through passage 20, a first cooling groove 21, and a second cooling groove 22. For example, water and oil may be used as the coolant. According to the preferred embodiment, oil 23 is employed as the coolant not only to cool the motor 2 and the brake device 1 but also to lubricate the drive motor 2. Specifically, the oil 23 is held in the casing 3 in an amount possible to immerse the motor shaft 6 at least partially, and to flow through the hollow passage 19 during operation of the drive motor 2.

The hollow passage 19 is formed in the motor shaft 6 of the motor 2 in the axial direction. Specifically, a leading end (of the left side in FIG. 1) of the hollow passage 19 is closed, and an opening 19a is formed on other end (of the right side in FIG. 1) to allow the oil 23 held in the casing 3 to flow into the hollow passage 19.

In addition, a through hole 19b is formed on the motor shaft 6 at a portion on which the brake rotor 9 is fitted to provide a connection between the hollow passage 19 and the through passage 20. In the preferred embodiment shown in FIG. 1, the same number of the through holes 19b as the through passages 20 are formed on the motor shaft 6 in the circumferential direction.

A plurality of the through passages 20 are formed in the brake rotor 9 in such a manner as to penetrate through the brake rotor 9 radially from the through holes 19b toward openings 9c at regular intervals.

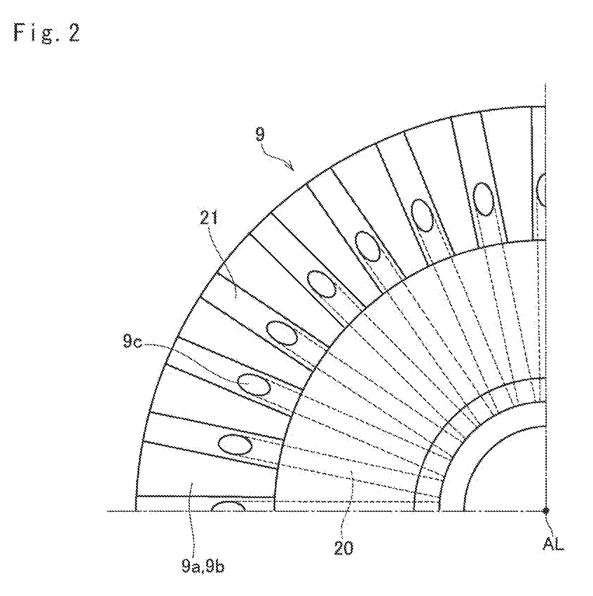

Specifically, as illustrated in FIG. 2, the through passages 20 extend radially in the brake rotor 9 at regular intervals around a rotational center axis AL of the motor shaft 6 toward an outer circumferential portion 9b of the brake rotor 9, and individually connected to the first cooling groove 21 formed on the first friction face 9a of the brake rotor 9 at the opening 9c.

In order to allow the oil 23 to flow radially on the first friction face 9a, a plurality of the first cooling grooves 21 are formed radially on the first friction face 9a from an inner circumferential edge to an outer circumferential edge of the first friction face 9a. Each of the first cooling groove 21 opens toward the second friction face 10a of the brake stator 10, and each of the openings 9c of the through passages 20 is individually formed on a bottom of the first cooling groove 21.

Specifically, the first cooling grooves 21 also extends radially on the first friction face 9a at regular intervals around the rotational center axis AL of the motor shaft 6, and both ends of each of the first cooling groove 21 are opened at the inner circumferential edge and the outer circumferential edge of the first friction face 9a. Thus, in the brake rotor 9, the oil 23 is allowed to flow from the inner circumferential edge to the outer circumferential edge of the first friction face 9a through the first cooling grooves 21.

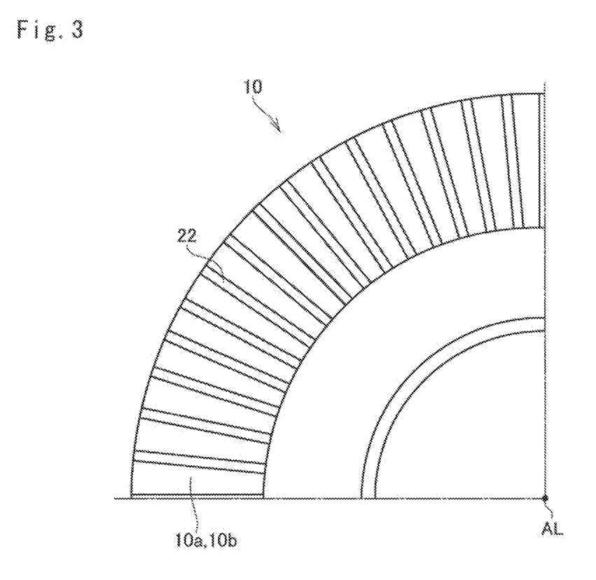

As illustrated in FIG. 3, the second cooling grooves 22 are formed on the second friction face 10a of the brake stator 10. Each of the second cooling groove 22 is individually opened to the first friction face 9a so that the oil 23 flowing through the first cooling grooves 21 partially flows into the second cooling grooves 22. Specifically, the same number of the second cooling grooves 22 as the first cooling grooves 21 are formed radially on the second friction face 10a of the brake stator 10 at regular intervals around the rotational center axis AL of the motor shaft 6.

In order to prevent interference between an opening edge of each of the first cooling groove 21 and an opening edge of each of the second cooling groove 22 when the second friction face 10a is brought into contact to the first friction face 9a, a width of each of the second cooling groove 22 is individually narrower than that of the first cooling groove 21.

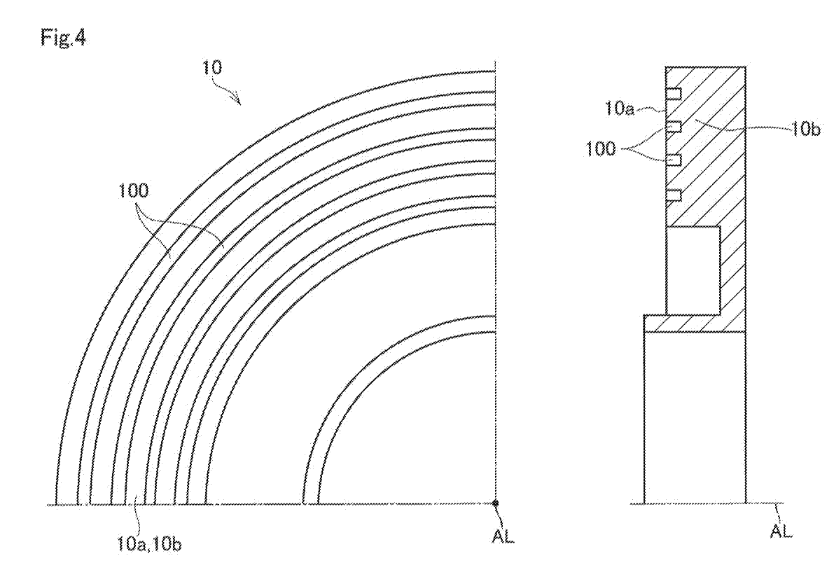

As illustrated in FIG. 4, the second cooling grooves may also be formed on the brake stator 10 in a circular manner. Specifically, as shown in FIG. 4, a plurality of the second cooling grooves 100 may be formed on the second friction face 10a of the brake stator 10 in a circular manner concentrically with one another. In this case, each of the second cooling groove 100 is also opened individually to the first friction face 9a so that the oil 23 flowing through the first cooling grooves 21 partially flows into the second cooling grooves 100. In addition, in order to cool the second friction face 10a by the oil flowing through the first cooling grooves 21, the second cooling grooves may also be formed on the second friction face 10a in a reticular pattern or spiral pattern.

As described, the oil 23 is held in the casing 3 so that the hollow passage 19 is filled with the oil 23. During operation of the motor 2, the motor shaft 6 and the brake rotor 9 are rotated so that the oil 23 in the hollow passage 19 is attracted to an inner circumferential face of the motor shaft 6 by the centrifugal action. Consequently, the oil 23 in the hollow passage 19 flows into the through passages 22 from the through holes 19b. In this situation, since the brake rotor 9 is also rotated together with the motor shaft 9, the oil 23 flowing into the through passages 20 is further attracted to the openings 9c by the centrifugal action.

The oil 23 flowing out of the openings 9c further attracted radially outwardly through the first cooling grooves 21, and eventually scattered from the outer circumference of the brake rotor 9. In this situation, the oil 23 flowing through the first cooling grooves 21 partially flows into the second cooling grooves 22 or 100. Consequently, the first friction face 9a is cooled by the oil 23 flowing through the first cooling grooves 21, and the second friction face 10a is cooled by the oil 23 flowing through the second cooling grooves 22 or 100.

As a result, an internal pressure of the hollow passage 19 becomes negative and hence the oil 23 flowing outside of the hollow passage 19 is sucked into hollow passage 19. Thus, the motor shaft 6 and the brake rotor 9 serve as a centrifugal pump.

The oil 23 scattered from the brake rotor 9 gravitationally drops in the casing 3, and sucked into the hollow passage 19 by the above-explained principle. Then, the oil 23 sucked into the hollow passage 19 is again scattered from the brake rotor 9 through the through passages 20 and the first cooling grooves 21. Thus, in the brake device 1, the motor shaft 6 and the brake rotor 12 serve as a centrifugal pump when rotated to centrifugally circulate the oil 23 within the casing 3.

In order to keep the liquid-tight condition in the casing 3, a clearance between the push rod 12 and the through hole 13 is sealed by an O-ring 24, and a clearance between the casing 3 and the brake motor 17 is sealed by an O-ring 25.

Although the above exemplary embodiment of the present application has been described, it will be understood by those skilled in the art that the present application should not be limited to the described exemplary embodiment, and various changes and modifications can be made within the spirit and scope of the present application. For example, configurations of the through passages 20 and the first cooling grooves 21 may also be altered arbitrarily as long as the motor shaft 6 and the brake rotor 12 are allowed to serve as a centrifugal pump. Specifically, the through passages 20 and the first cooling grooves 21 may also be inclined or curved with respect to the radial direction.

Thus, the first cooling grooves 21 are formed on the brake rotor 9 from the inner circumferential edge to the outer circumferential edge of the first friction face 9a so that the oil 23 can be delivered from the inner circumferential side to the outer circumferential side of the first friction face 9a by the centrifugal action when the brake rotor 9 is rotated. That is, the motor shaft 6 and the brake rotor 12 serve as a centrifugal pump. In the brake device 1, therefore, the first friction face 9a can be cooled effectively by the oil 23.

In the brake device 1, the second cooling grooves 22 or 100 are also formed on the second friction face 10a of the brake stator 10. Each of the second cooling groove 22 or 100 is individually opened to the first friction face 9a so that the oil 23 flowing through the first cooling grooves 21 is allowed to partially flow into the second cooling grooves 22 or 100. In the brake device 1, therefore, the second friction face 10a may also be cooled effectively by the oil 23.

In addition, when the second friction face 10a is brought into contact to the first friction face 9a, each of the first cooling groove 21 is almost closed by the second friction face 10a. Consequently, pumping pressure of the centrifugal pump formed by the motor shaft 6 and the brake rotor 12 can be enhanced. In the brake device 1, therefore, a flow rate of the oil 23 flowing through the first cooling grooves 21 may be increased to cool the brake rotor 9 more effectively when the second friction face 10a is brought into contact to the first friction face 9a. Also, a flow rate of the oil 23 flowing through the second cooling grooves 22 or 100 may also be increased to cool the brake stator 10 more effectively.

By contrast, when the second friction face 10a is isolated away from the first friction face 9a, pumping pressure of the centrifugal pump formed by the motor shaft 6 and the brake rotor 12 is reduced, and consequently the frictional resistance between the brake rotor 9 and the oil 23 is reduced. In this case, a frictional loss between the brake rotor 9 and the oil 23 may be reduced.

What is claimed is:

1. A brake device, comprising:
a brake stator that is restricted to rotate around a predetermined rotary shaft;
a brake rotor that is fitted onto the rotary shaft in such a manner as to rotate integrally with the rotary shaft and relatively to the brake stator;
a casing holding the brake stator and the brake rotor;
a first friction face formed on an outer circumferential portion of the brake rotor and a second friction face formed on an outer circumferential portion of the brake stator that are brought into contact with each other to stop rotation of the rotary shaft;
a hollow passage formed in the rotary shaft;
a coolant held in the casing to cool the brake stator and the brake rotor in an amount possible to immerse the rotary shaft at least partially and to flow through the hollow passage;
a first cooling groove formed on the brake rotor in such a manner as to open toward the second friction face, so as to allow the coolant to flow from an inner circumferential edge to an outer circumferential edge of the first friction face; and
a through passage penetrating through the brake rotor across the rotary shaft to allow the coolant flowing through the hollow passage to flow into the first cooling groove.

2. The brake device as claimed in claim 1, further comprising:
a second cooling groove formed on the second friction face that opens toward the first friction face to allow the coolant flowing through the first cooling groove partially enters thereinto.

3. The brake device as claimed in claim 1, wherein a plurality of the first cooling grooves and a plurality of the through passages are formed radially around a rotational center axis of the rotary shaft.

4. The brake device as claimed in claim 1, wherein the brake stator is magnetically attracted toward the brake rotor when energized to stop the rotation of the rotary shaft.

5. The brake device as claimed in claim 1,
wherein a motor in which the rotary shaft serves as an output shaft is also held in the casing, and
wherein the coolant not only cools the brake stator and the brake rotor but also cools and lubricates the motor.
